(19) United States
(12) Patent Application Publication
(10) Pub. No.: US 2007/0227959 A1
(43) Pub. Date: Oct. 4, 2007

(54) Filter cartridges and methods

(76) Inventors: Richard R. Sinur, Grafton, WI (US); Michael R. Brewster, Sheboygan, WI (US); Ken Kusel, Kohler, WI (US); Michael J. Kurth, Howards Grove, WI (US); Roland Schwarz, Waldo, WI (US); Satyajit Mahdav Prabhu, New Delhi (IN); Rahul Sadashiv Kamble, Maharashtra (IN); Manu Verma, New Delhi (IN)

Correspondence Address: MICHAEL BEST & FRIEDRICH LLP, 100 E WISCONSIN AVENUE, Suite 3300, MILWAUKEE, WI, 53202, US

(21) Appl. No.: 11/394,647

(22) Filed: Mar. 31, 2006

(51) Int. Cl. B01D 27/00

(52) U.S. Cl. 210/232; 210/435; 210/470

(57) ABSTRACT

Filter cartridges and methods of use with manifolds of appliances. The filter cartridges can includes components, such as handles, levers, cams, rotatable nuts, actuators, pins, and springs, to assist in removing the filter cartridge from the manifold. Some embodiments of the filter cartridges can include a neck having a non-uniform diameter over a longitudinal length. Other embodiments of the filter cartridges can include a recess that receives a portion of the manifold and the recess can have at least one seal. One embodiment of the invention provides an adapter for use between a manifold and a filter.

### FIELD OF THE INVENTION

The invention relates to filter cartridges and methods of use. More specifically, the invention relates to removable water filter cartridges used with household refrigerators or other appliances.

### BACKGROUND

Many household refrigerators are equipped with water filtration units which provide an easily accessible source of purified water. Generally, such filtration units include a head unit or manifold that is permanently fixed to the refrigerator and a disposable filter cartridge that is removably coupled to the manifold. In some instances, seals on the filter cartridge become stuck to the manifold of the refrigerator, making removal of the filter cartridge somewhat difficult. Accordingly, filter cartridges and methods have been developed for existing manifolds to help remove the filter cartridge from the manifold.

### SUMMARY

In one embodiment, the invention provides a filter cartridge for use with a manifold of an appliance. The filter cartridge can include a base portion having a top and a bottom, and a handle coupled to the bottom of the base portion, the handle adapted to be grasped in order to remove the filter cartridge from the manifold.

Other embodiments of the invention provide a filter cartridge including a filter body having a top and a filter cap coupled to the top of the filter body. The filter cap can include a first top surface and a raised portion coupled to the first top surface. The raised portion can include a second top surface and a neck coupled to the second top surface.

In some embodiments, the raised portion can include a tab positioned substantially parallel to the second top surface or a single cam element including three portions. In some embodiments, the raised portion can also include a ramp or a fulcrum and a lever. In some embodiments, the tab, the raised portion, or a top surface of the filter cap can include a spring to bias the filter cartridge away from the manifold. In one embodiment, the filter body can include a rotatable nut to engage the manifold. In some embodiments, the filter cap can include a release assembly with moving pins, levers, or actuators. In some embodiments, the neck or a top surface of the filter cap can include one or more end stops.

According to some embodiments of the invention, a neck of the filter cartridge can include at least one step and at least one substantially straight or annular wall providing a non-uniform thickness along a longitudinal length.

In one embodiment, the filter cartridge can include a recess (and not a neck) including at least one seal. Some embodiments of the invention provide an adapter for use between a manifold and a filter.

Other aspects of the invention will become apparent by consideration of the detailed description and accompanying drawings.

### BRIEF DESCRIPTION OF THE DRAWINGS

FIG. 1A is a perspective view of an exemplary filter cartridge having an integrated handle.

FIG. 1B is a perspective view of an exemplary filter cartridge having a strap handle.

FIG. 1C is a perspective view of an exemplary filter cartridge having a T-bar handle.

FIG. 1D is a perspective view of an exemplary filter cartridge having a block handle.

FIG. 1E is a perspective view of an exemplary filter cartridge having a tapered block handle.

FIG. 1F is a perspective view of an exemplary filter cartridge having a squared handle.

FIG. 2 is a front view of an exemplary filter cartridge having an uninterrupted cam.

FIG. 3A is a front view of an exemplary filter cap.

FIG. 3B is another front view of the exemplary filter cap shown in FIG. 3A.

FIG. 4A is a front view of an exemplary filter cartridge having a nut.

FIG. 4B is another front view of the filter cartridge having the nut shown in FIG. 4A.

FIG. 4C is a front view of an exemplary filter cap and a nut.

FIG. 4D is another front view of the filter cap and the nut shown in FIG. 4C.

FIG. 5A is a front view of an exemplary filter cap having a pair of levers.

FIG. 5B is another front view of the exemplary filter cap having a pair of levers shown in FIG. 5A.

FIG. 6A is a cross sectional view of an exemplary filter cartridge having a spring-biased ring.

FIG. 6B is a cross sectional view of an exemplary filter cartridge having a spring-biased neck.

FIG. 7A is a front view of an exemplary filter cap having a raised portion that includes a pair of springs.

FIG. 7B is a front view of an exemplary filter cap having a rounded spring element.

FIG. 7C is a front view of an exemplary filter cartridge having a pair of spring-loaded buttons.

FIG. 7D is a front view of an exemplary filter cartridge having a pair of elongated spring elements.

FIG. 7E is a top view the exemplary filter cartridge shown in FIG. 7D.

FIG. 7F is a front view of an exemplary filter cartridge having an elongated and rounded spring element.

FIG. 7G is a perspective view of an exemplary curved spring element.

FIG. 7H is a front view of the curved spring element shown in FIG. 7G.

FIG. 8A is a front view of an exemplary filter cap having a lever that is movable about a fulcrum.

FIG. 8B is another front view of the exemplary filter cap shown in FIG. 8A.

FIG. 9A is a front view of an exemplary filter cap having a horizontally oriented pin and a vertically oriented pin.

FIG. 9B is another front view of the exemplary filter cap shown in FIG. 9A.

FIG. 10A is a front view of an exemplary filter cap having a dual-pronged release assembly.

FIG. 10B is another front view of the exemplary filter cap shown in FIG. 10A.

FIG. 11A is a perspective view of an exemplary filter cap having a release lever.

FIG. 11B is another perspective view of the exemplary filter cap shown in FIG. 11A.

FIG. 11C is a perspective view of another exemplary filter cap having a spring-loaded and resettable actuator and a release lever.

FIG. 12A is a perspective view of an exemplary filter cartridge having a neck that includes a stepped portion.

FIG. 12B is a cross sectional view of the exemplary filter cartridge shown in FIG. 12A.

FIG. 13A is a perspective view of an exemplary filter cartridge having a recess and a pair of annular seals.

FIG. 13B is a cross sectional view of the exemplary filter cartridge shown in FIG. 13A.

FIG. 14A is a perspective view of an exemplary filter cartridge adapter.

FIG. 14B is a perspective view of the exemplary filter cartridge adapter and a filter body.

FIG. 15A is a perspective view of an exemplary filter cartridge having a neck that includes a radiused portion.

FIG. 15B is a cross sectional view of the exemplary filter cartridge shown in FIG. 15A.

FIG. 16A is a perspective view of an exemplary filter cartridge having a filter cap and a filter body combination that have an extendible capability.

FIG. 16B is another perspective view of the exemplary filter cartridge shown in FIG. 16B.

FIG. 17 is a perspective view of another exemplary filter cartridge having a filter cap and a filter body combination that have an extendible capability.

FIG. 18A is a perspective view of an exemplary filter cartridge having a handle.

FIG. 18B is another perspective view of the exemplary filter cartridge shown in FIG. 18A.

FIG. 19A is a perspective view of an exemplary filter cartridge handle.

FIG. 19B is a bottom view of the exemplary filter cartridge handle shown in FIG. 19A.

FIG. 19C is a perspective view of an exemplary support loop that can be used with the filter cartridge handle shown in FIG. 19A.

FIG. 19D is another perspective view of the exemplary filter cartridge handle shown in FIG. 19A.

FIG. 19E is a front view of the exemplary filter cartridge handle shown in FIG. 19A.

FIG. 19F is yet another perspective view of the exemplary filter cartridge handle shown in FIG. 19A.

FIG. 20A is a perspective view of an exemplary filter cap having a pair of end stops.

FIG. 20B is a perspective view of another exemplary filter cap having a pair of end stops.

FIG. 20C is a perspective view of yet another exemplary filter cap having a pair of end stops.

FIG. 21A is a top view of an exemplary filter cap having a pair of end stops and four ribs.

FIG. 21B is a top view of another exemplary filter cap having a pair of end stop and two ribs.

FIG. 21C is a perspective view of the exemplary filter cap shown in FIG. 21A.

FIG. 21D is a perspective view of the exemplary filter cap shown in FIG. 21B.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Finally, while the filter cartridges described herein generally use bayonet-mount configurations to mount the cartridges on manifolds, it will be apparent that other mounting configurations can be used.

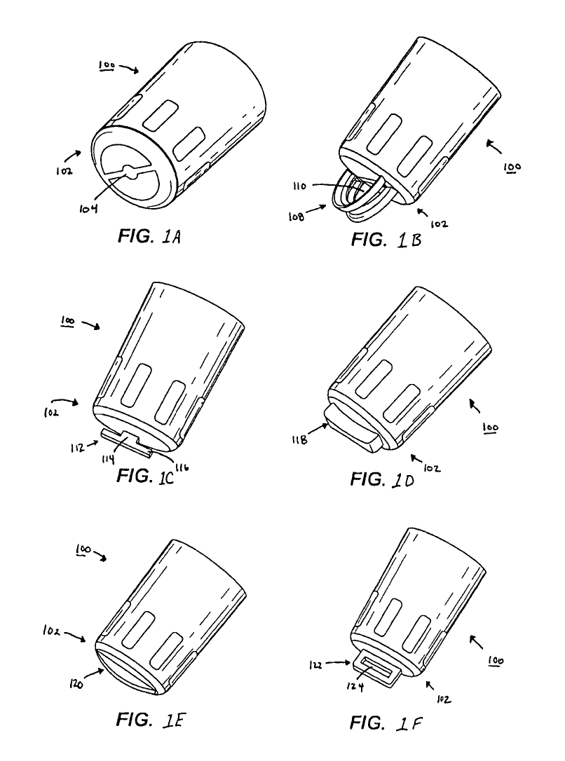

FIG. 1A illustrates a filter cartridge 100 that includes a base portion 102. The filter cartridge 100 can be coupled to the manifold (or head unit) of a refrigerator to provide a source of filtered water for a user. In some instances, seals on the filter cartridge 100 become stuck to the manifold of the refrigerator, making removal of the filter cartridge 100 somewhat difficult. Accordingly, filter cartridges and methods have been developed for existing manifolds to help remove the filter cartridge 100 from the manifold. Accordingly, in some embodiments, an integrated handle 104 is formed into the base portion 102, such that a user can grasp a grip portion 106 of the integrated handle 104 in order to pull the filter cartridge 100 away from the manifold. The integrated handle 104 can be molded directly into the filter cartridge 100 during manufacture or added to a preexisting filter cartridge.

FIG. 1B illustrates another filter cartridge 100 that includes a strap handle 108 in an extended position. In some embodiments, the strap handle 108 can be transitioned from the extended position shown in FIG. 1B to a collapsed position (not shown) when the handle is not in use. The collapsed position can minimize the overall size of the filter cartridge 100, and can also provide a more aesthetically-pleasing filter cartridge. The strap handle 108 can include one or more strap elements that can be coupled to the base portion 102 in two or more positions. For example, in one embodiment, the strap handle 108 can be a single strap element that is comprised of a flexible plastic material. The strap handle 108 can span with width of the base portion 102 in a half-circle such that an open area 110 is included between the strap handle 108 and the base portion 102. The open area 110 can be sized to allow a user to insert his or her hand through the open area 110. Accordingly, the user can grasp the strap handle 108 to aid in the removal of the filter cartridge 100 from the manifold of the refrigerator. The strap handle 108 can be molded directly into the filter cartridge 100 during manufacture or over-molded onto an existing filter cartridge 100.

FIG. 1C illustrates another filter cartridge 100 that includes a T-bar handle 112. The T-bar handle 112 can include a center piece 114 that can be coupled to the center of the base portion 102. The T-bar handle can also include two or more projections 116 that can extend from the center piece 114. The projections 116 can be sized such that the user can grasp the projections 116 of the filter cartridge 100 from the manifold of the refrigerator. The length and width of the center piece 114 and projections 116 can vary according to the configuration of the refrigerator, as well as the desired style of the filter cartridge 100. The T-bar handle 112 can be molded directly into the filter cartridge 100 during manufacture or over-molded onto an existing filter cartridge 100.

FIG. 1D illustrates another filter cartridge 100 that includes a block handle 118. The block handle 118 can be coupled to the base portion 102, and can be variably dimensioned according to the configuration of the refrigerator and the desired style of the filter cartridge 100. For example, in one embodiment, the block handle 118 can span almost the entire width of the base portion 102 and can protrude approximately two inches from the base portion 102. In other embodiments, the block handle 118 may extend across only a certain section of the base portion 102 (e.g., a central area of the base portion 102), or may protrude more or less from the base portion 102. During use, a user can grasp the block handle 118 to help remove the filter cartridge 100 from the manifold of the refrigerator. The block handle 118 can be molded directly into the filter cartridge 100 during manufacture or over-molded onto an existing filter cartridge 100.

FIG. 1E illustrates another filter cartridge 100 that includes a tapered block handle 120. Similar to the block handle 118, the tapered block handle 120 can be coupled to the base portion 102, and can be variably dimensioned according to the configuration of the refrigerator and the desired style of the filter cartridge 100. In an embodiment, the tapered block handle 120 spans approximately the entire width of the base portion 102, having a protruding section in the center of the base portion 102 that is generally greater than the protruding sections toward the outer edges of the base portion 102. Accordingly, the “crescent-moon shaped” tapered block handle 120 can blend with the overall contour of the filter cartridge 100, which may create a more aesthetically pleasing filter cartridge. The tapered block handle 120 can be molded directly into the filter cartridge 100 during manufacture or over-molded onto an existing filter cartridge 100.

FIG. 1F illustrates another filter cartridge 100 that includes a squared handle 122. The squared handle 122 can be coupled to the base portion 102, and can include an opening 124. The squared handle 122 and opening 124 can be sized such that a user can grasp the squared handle 122 through the opening 124 to aid in the removal of the filter cartridge 100 from the manifold of the refrigerator. For example, in an embodiment, the squared handle 122 can be positioned in the center of the base portion 102, and the opening 124 can be wide enough for a hand of the user to extend through the opening 124. In other embodiments, the squared handle 122 can be located in another position (e.g., elsewhere on the base portion 102, on a side of the filter cartridge 100, etc.) and can be dimensioned differently (e.g., having an alternative length, having a larger or smaller opening 124, etc.). The squared handle 122 can be molded directly into the filter cartridge 100 during manufacture or over-molded onto an existing filter cartridge 100.

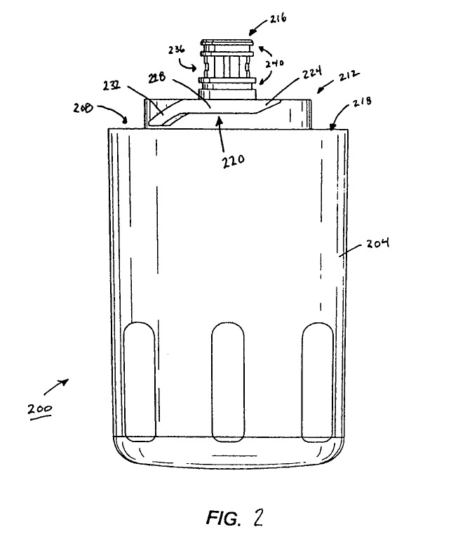

FIG. 2 illustrates a filter cartridge 200. In one embodiment, the filter cartridge 200 can be made compatible with Maytag brand refrigerators (and manifolds). The filter cartridge 200 can include a main housing or filter body 204 that houses filter media (not shown). The filter cartridge 200 can also include a filter cap 208 having a raised portion 212 and a neck 216. The filter cap 208 is attached to the top of the filter body 204, sealing the filter media within the filter body 204. The raised portion 212 protrudes from a top surface 218 of the filter cap 208. In some embodiments, the raised portion 212 has a smaller thickness than the diameter of the filter cap 208. The neck 216 can protrude from the raised portion 212 of the filter cap 208. The neck 216 can be cylindrical, but can also be non-uniform in diameter or thickness along its length.

When the filter cartridge 200 is coupled to the manifold, the neck 216 is inserted into the manifold, and the filter cartridge 200 is rotated to secure the filter cartridge 200 in the proper position (described below). Fluid inlet openings 236 in the neck 216 communicate with a hollow cylindrical chamber within the neck 216 (not shown), providing a path for liquid (from the manifold) to access the filter media in the filter cartridge body 204. The liquid is then circulated back to the manifold through an outlet port located in the top surface of the neck 216. In some embodiments, the neck 216 can include one or more 0-ring seal seats 240, which can accept one or more 0-ring seals to prevent fluid from leaking between the outer surfaces of the filter cap 208 (i.e., the outer surfaces of the neck 216 and the raised portion 212) and the corresponding mating surfaces of the manifold when the filter cartridge 200 is coupled to the manifold.

In some embodiments, the raised portion 212 can include a single, substantially uninterrupted cam element 220, which protrudes from the side of the raised portion 212 and includes a first cam portion 224, a middle cam portion 228, and an end cam portion 232. The single cam element 220 can help couple the filter cartridge 200 to the manifold, as well as removing the filter cartridge 200 from the manifold of the refrigerator. For example, the uninterrupted cam element 220 can interface with the manifold such that the first cam portion 224 of the single cam element 220 draws the filter cartridge 200 closer to the manifold (forcing a greater portion of the neck 216 into the manifold) as the filter cartridge 200 is rotated. After following the middle cam portion 228 of the cam element 220, which is relatively parallel to the base or bottom of the filter cartridge body 204. The filter cartridge 200 is fully coupled to the manifold.

To release the filter cartridge 200 from the manifold, the filter cartridge 200 can be rotated in the opposite direction, which causes the mating elements of the manifold to follow the cam element 220 in the opposite direction. The end cam portion 232 of the cam element 220 helps to decouple the filter cartridge 200 from the fully mated position, while the first cam portion 224 of the cam element 220 helps to remove the neck 216 from the orifice of the manifold.

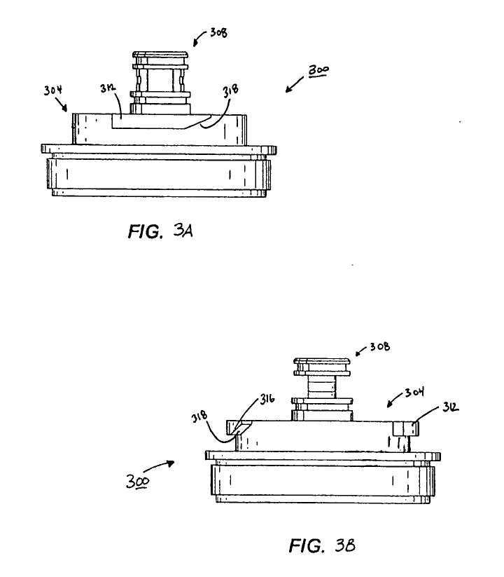

FIGS. 3A and 3B illustrate an embodiment of a filter cap 300 having a raised portion 304 and a neck 308. In some embodiments, the filter cap 300 can be coupled to a filter body, similar to the filter cap 208 and filter body 204 shown in FIG. 2. Additionally, the neck 308 can be configured similar to the neck 216 (shown in FIG. 2) such that the neck 308 can be inserted into the manifold of the refrigerator when the filter cap 300 is coupled to the manifold. The raised portion 304 of the filter cap 300, however, can include a first rectangular tab 312 and a second rectangular tab 316 (see FIG. 3B). Additionally, the first and second rectangular tabs 312 and 316 can include a cam portion 318.

The first rectangular tab 312 and second rectangular tab 316 can be located opposite each other on the raised portion 304, and can be sized to interface with the manifold of the refrigerator. The filter cap 300 can be coupled to a manifold by inserting the neck 308 into an orifice of the manifold until the manifold interfaces with the cam portion 318 of the first rectangular tab 312 and the second rectangular tab 316. In some embodiments, the cam portion 318 can be used aid in the initial coupling of the filter cap 300 and the manifold. For example, the cam portion 318 can be used to draw the first and second rectangular tabs 316 and 316 into the manifold when the filter cap 300 is rotated. Accordingly, a water tight seal is created between the manifold and the filter cap 300. To decouple the filter cap 300 from the manifold, the filter can be rotated one-half revolution in the opposite direction (i.e., opposite the securing direction). The decoupling rotation of the filter cap 300 disengages the first and second rectangular tabs 312 and 316 from the manifold, thereby allowing a user to remove the neck 308 from the manifold.

In other embodiments, the first rectangular cam 312 and the second rectangular cam 316 can be configured differently than the ramps shown in FIGS. 3A and 3B. For example, the first rectangular cam 312 and the second rectangular cam 316 can protrude from the side of the raised portion 304 further or less than shown. Additionally or alternatively, the first rectangular cam 312 and the second rectangular cam 316 can have alternative lengths and widths.

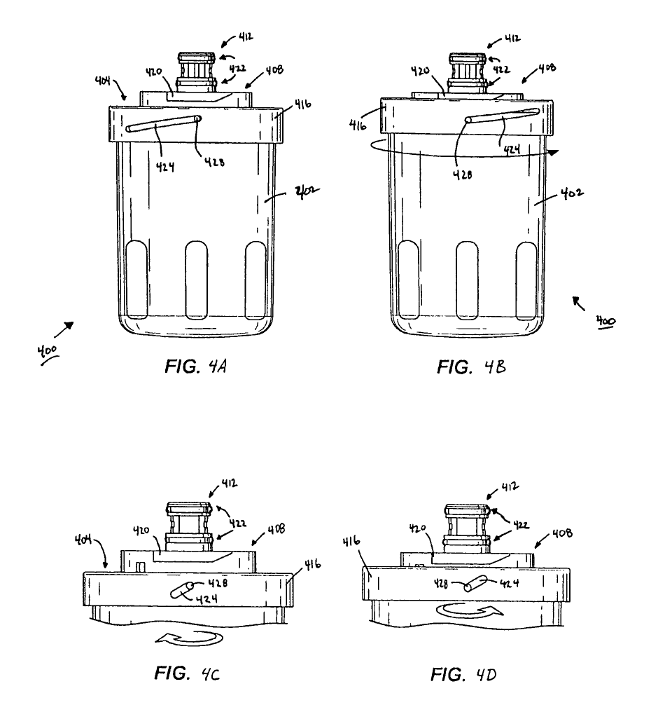

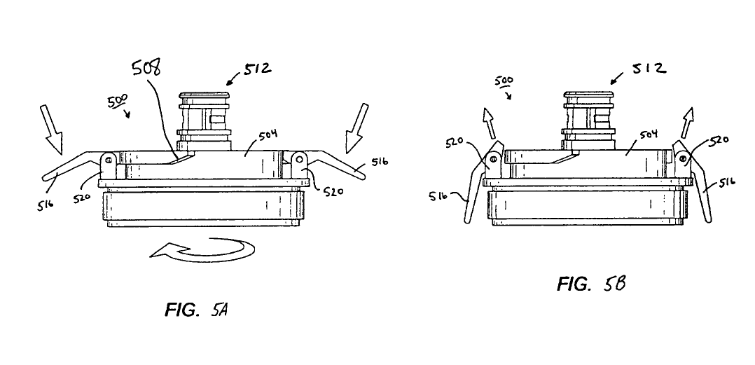

FIGS. 4A-4D illustrate an embodiment of a filter cartridge 400 that includes a filter body 402 and filter cap 404 having a raised portion 408 and a neck 412. In some embodiments, the components of the filter cartridge 400 (e.g., the body 402, the neck 412, etc.) can be configured similar to those depicted in FIGS. 2-3B. However, the filter cartridge 400 can also include a nut 416 that is coupled to the filter body 402 on the surface of the filter body 402. The nut 416 can be used to aid in disengaging the filter cartridge 400 from a refrigerator manifold (not shown).

The filter cartridge 400 can be coupled (or mated) to the manifold by inserting the neck 412 into the orifice of the manifold (not shown) and rotating the filter cartridge 400 one-half revolution. Rotating the filter cartridge 400 causes a tab 420 on the raised portion 408 of the filter cap 404 to interface with the manifold such that a fluid tight seal is created between the filter cap 404 and the manifold. In some embodiments, coupling the filter cartridge 400 to the manifold can be performed with the nut 416 in a lowered position, as shown in FIGS. 4A and 4C, which positions the nut 416 below the upper surface of the filter cap 404. The nut 416 can be moved to the lowered position by holding the filter body 402 and rotating the nut 416 counterclockwise.

The filter cartridge 400 can be disengaged from the manifold by rotating the filter cartridge 400 one-half revolution in the direction opposite the coupling direction. Rotating the filter cartridge 400 can free the tab 420 of the manifold; however, the o-ring seals 422 on the neck 412 may be stuck to the manifold and cause the neck 412 of the filter cartridge 400 to remain engaged with the manifold. To fully disengage the filter cartridge 400 from the manifold, the nut 416 can be rotated to a raised position, as shown in FIGS. 4B and 4D. Rotating the nut 416 to the raised position can cause the top surface of the nut 416 to contact the manifold, thereby forcing the upper surface of the filter cap 404 away from the manifold.

In some embodiments the nut 416 is retained and guided by a slot 424 and a pin 428 mechanism. For example, in one embodiment, the pin 428 is positioned at or near the top of the slot 424 when the nut 416 is in the lowered position (see FIG. 4C). The nut 416 rotates to its raised position (see FIG. 4D) due to the slot 424 engaging the substantially rigid pin 428. In other embodiments, the nut 416, slot 424, and pin 428 can be reversed or otherwise configured differently, having different dimensions and orientations. Additionally or alternatively, the nut 416 can be retained and guided be one or more threads included on the nut 416 and/or filter body 402. For example, conventional threads can be used to guide the nut 416 from the lowered position (see FIG. 4A) to the raised position (see FIG. 4B) instead of, or in addition to, the slot 424 and the pin 428.

FIGS. 5A and 5B illustrate an embodiment of a filter cap 500 that includes a raised portion 504 having a cam 508 and a neck 512. The filter cap 500 also includes a pair of levers 516 that are disposed opposite each other on the filter cap 500. The levers 516 are movable about a fulcrum 520 that is coupled to the upper surface of the filter cap 500. In some embodiments, the filter cap 500 can be coupled to the manifold of the refrigerator in the same manner described with respect to FIGS. 4A-4D. However, prior to coupling the filter cap 500 to the manifold, the levers 516 can be positioned in a first raised position, as shown in FIG. 5A, which generally aligns a top surface 524 of the levers 516 with the top surface of the raised portion 504. Aligning the top surface 524 of the levers 516 with the top surface of the raised portion 504 allows the raised portion 504 to make a fluid tight seal with the manifold of the refrigerator when coupling the filter cap 500 to the manifold. To disengage the filter cap 500 from the manifold, the levers 516 can be moved to a second lowered position, as shown in FIG. 5B, which causes a portion of the levers 516 to extend beyond the upper surface of the raised portion, and contact the manifold. Accordingly, the levers 516 can provide an extra force to separate the raised portion 504 from the manifold.

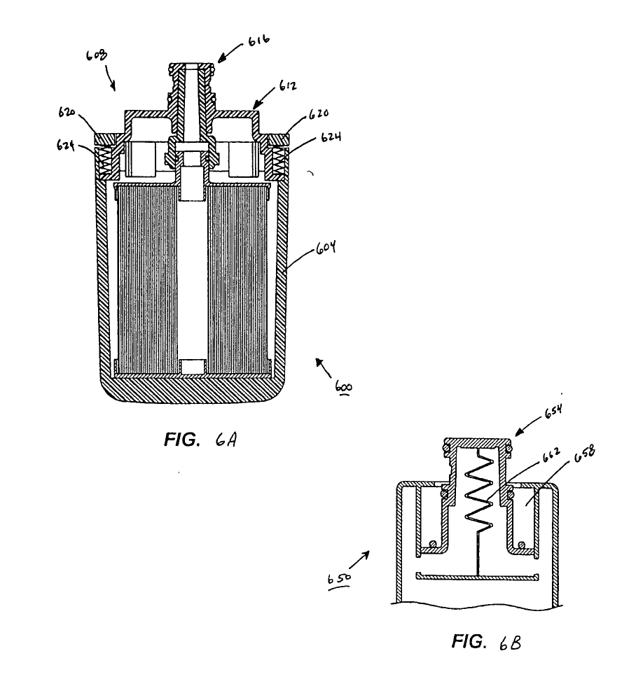

FIG. 6A is a cross-sectional view of an exemplary filter cartridge 600 having a filter body 604 and a filter cap 608. In some embodiments, the filter cap 608 includes a raised portion 612 that has a neck 616, similar to the embodiments described above. However, the filter cap 608 can also include disengagement blocks 620 that are biased by springs 624. When the filter cap 608 of the filter cartridge 600 is coupled to a manifold of a refrigerator, the springs 624 can be compressed such that an upper surface 628 of the disengagement blocks 620 is substantially flush with an upper surface 632 of the filter cap 608. Accordingly, the filter cap 608 can be secured to the manifold of the refrigerator, and a fluid tight seal can be created between the filter cap 608 and the manifold. When the filter cap 608 is rotated to disengage from the manifold of the refrigerator, the springs 624 can bias the disengagement blocks 620 against the manifold such that the filter cap 608 is forced away from the manifold.

FIG. 6B illustrates another embodiment of a filter cap 650 that includes a neck 654 that can move within a neck opening 658 and that can be biased by a spring element 662. In an embodiment, the neck 654 is “spring loaded” by the spring element 662 such that the neck 654 can move within the neck opening 658 when the filter cap 650 is coupled to, and decoupled from, the manifold of the refrigerator. For example, when the filter cap 650 is coupled to the manifold, the spring element 662 can compress to a level that allows the filter cap 650 to move within the neck opening 658 such that the filter cap 650 can be fully coupled to the manifold. When the filter cap 650 is rotated for disengagement from the manifold, the spring element 662 provides a force that pushes the filter cap 650 away from the manifold.

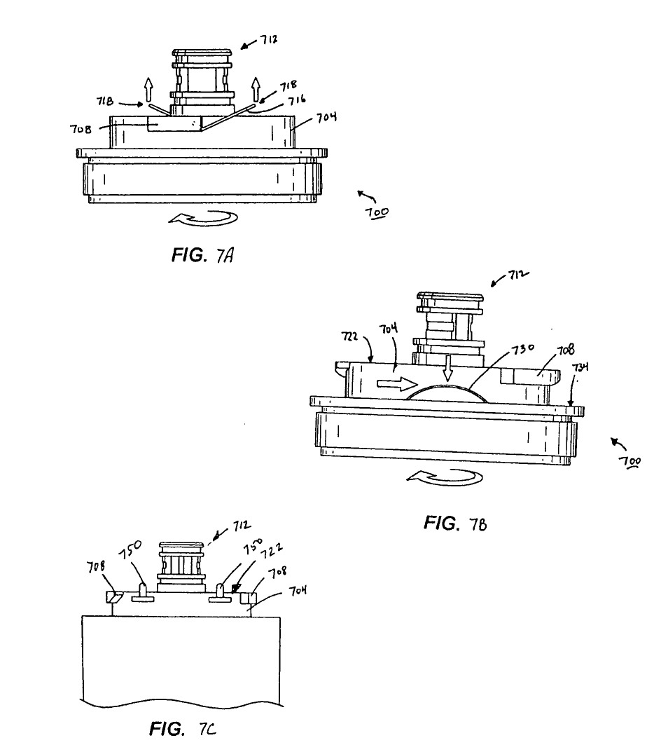

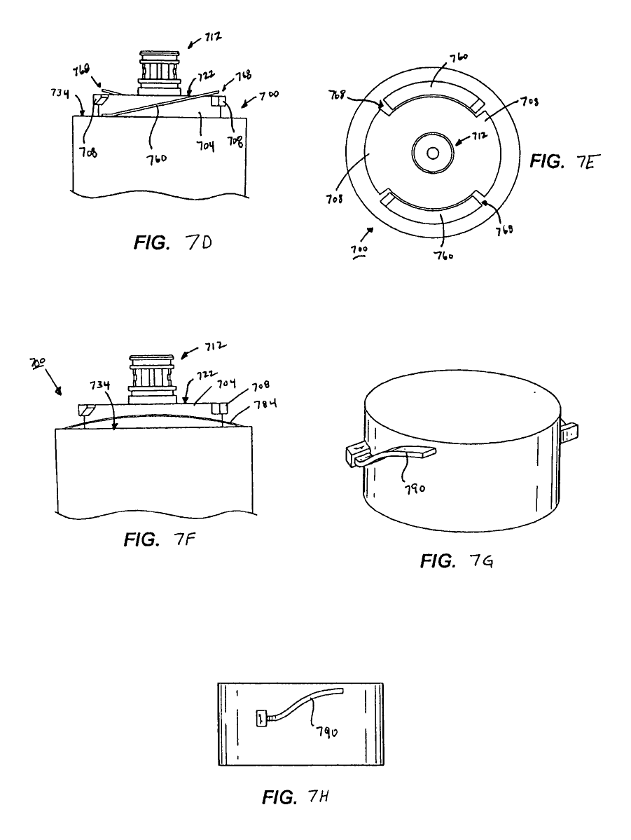

FIG. 7A illustrates a filter cap 700 that includes a raised portion 704 having a tab 708 and a neck 712. Additionally, in some embodiments, spring elements 716 are coupled to the tab 708 such that an end portion 718 of the spring elements 716 is positioned above an upper surface 722 of the raised portion 704. The end portions 718 can be chamfered or bent toward the raised portion 704 to prevent gouging of the manifold. The filter cap 700 can be secured to the refrigerator by interfacing that tab 708 with the manifold as previously described. When the filter cap 700 is coupled to the manifold, the end portion 718 of the spring element 716 can be compressed, and forced below the upper surface 722 of the raised portion 704. After the tab 708 has been disengaged from the manifold (e.g., by rotating the filter cap 700 in the disengaging direction), the end portion 718 of the spring element 716 forces the upper surface 722 of the raised portion 704 away from the manifold.

FIG. 7B illustrates another embodiment of the filter cap 700 having a curved spring element 730 that is coupled to a top surface 734 of the filter cap 700. When the filter cap 700 is coupled to the manifold, the curved spring element 730 is compressed between the top surface 734 of the filter cap 700 and a surface of the manifold (not shown). Similar to the spring element 716, the curved spring element 730 can help disengage the filter cap 300 from the manifold of the refrigerator by pushing the filter cap 700 away from the manifold of the refrigerator.

FIG. 7C illustrates another embodiment of the filter cap 700 that includes a pair of spring-biased buttons 750 that are coupled to the raised portion 704. In some embodiments, the top of the spring-biased buttons 750 protrude above the upper surface 722 of the raised portion 704. Accordingly, the spring-biased buttons 750 can be compressed when the filter cap 700 is coupled to the manifold of the refrigerator, so that the upper surface 722 of the raised portion 704 can interface with the manifold. When the filter cap 700 is rotated to disengage it from the manifold, the spring-biased buttons 750 push the filter cap 700 away from the manifold.

FIGS. 7D-7E illustrate another embodiment of the filter cap 700 that includes a pair of elongated spring elements 760. The elongated spring elements 760 can be configured similarly to the spring elements 716 described with respect to FIG. 7A. However, the elongated spring elements 760 can be coupled to the upper surface 734 of the filter cap 700, rather than to the tabs 708. In some embodiments, the elongated spring elements 760 span the entire space between each of the tabs 708. In other embodiments, the elongated spring elements 760 may only extend a portion of the distance between each of the tabs 708. Ends 768 of the elongated spring elements 760 can extend above the upper surface 722 of the raised portion 704. Accordingly, the spring elements 760 are compressed when the filter cap 700 is coupled to the manifold of the refrigerator. When the filter cap 700 is rotated to disengage it from the manifold, the ends 768 of the elongated spring elements 760 pushing against the manifold help remove the filter cap 700 from the manifold.

FIG. 7F illustrates an embodiment of the filter cap 700 that includes an elongated and rounded spring element 784 that is coupled to the upper surface 734 of the filter cap 700. In some embodiments, the elongated and rounded spring element 784 is coupled to the upper surface 734 at the edge of the filter cap 700, such that the elongated and rounded spring element 784 spans the width of one side of the filter cap 700 (as shown in FIG. 7F). The elongated and rounded spring element 784 is compressed when the filter cap 700 is coupled to the manifold of the refrigerator. Accordingly, when the filter cap 700 is decoupled from the manifold of the refrigerator, the elongated and rounded spring element 784 can decompress and bias the filter cap 700 away from the manifold of the refrigerator. In some embodiments, a second elongated and rounded spring element is included, and can be coupled to the filter cap 700 on the other side of the filter cap 700 (i.e., the side not shown in FIG. 7F).

FIGS. 7G-7H illustrate another embodiment of a curved spring element 790. In some embodiments, the curved spring element 790 can be curved in an “S” shape. In other embodiments, the curved spring element 790 can be formed in substantially different shapes. Additionally, in some embodiments, the curved spring element 790 can be coupled to the tabs 708 on the raised portion 704 of the filter cap 700 (see FIGS. 7A-7F). Alternatively, the curved spring element 790 can be coupled to the filter cap 700 in a different location, or can be coupled to a different style of filter cap. The curved spring element 790 can compress and extend in a manner that helps a filter cap (such as the filter cap 700) be removed from the manifold of the refrigerator.

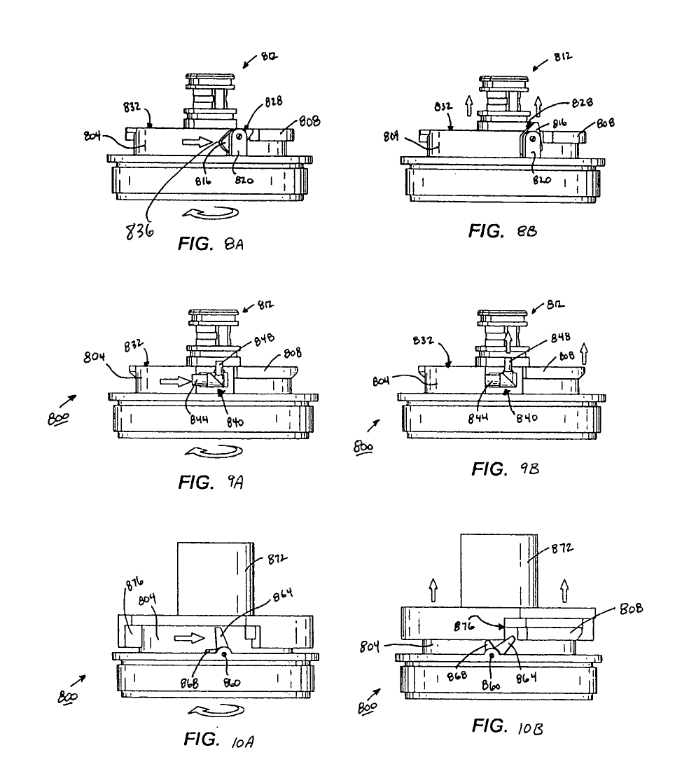

FIGS. 8A-8B illustrate a filter cap 800 that includes a raised portion 804 having a tab 808 and a neck 812. Additionally, in some embodiments, a lever 816 that is movable about a fulcrum 820 is coupled to a top surface 824 of the filter cap 800. The lever 816 includes an end portion having an angled edge 328. The lever 816 can be positioned so that the angled edge of the end portion 328 is positioned generally flush with a top surface 832 of the raised portion 804 (see FIG. 8A). In some embodiments, however, the lever 816 is spring loaded (or otherwise tensioned) such that the lever 816 is biased to toward an upright position (see FIG. 8B). The lever 816 can help disengage the filter cap 800 from the manifold by pivoting about the fulcrum 820 when the tab 808 is removed from the manifold. For example, as shown in FIG. 8A, the lever 816 can be positioned such that the angled edge 828 arranged generally flush with the top surface 832 of the raised portion 804 when the filter cap is mated to the manifold, which allows a fluid tight seal to be created between the top surface 832 and the manifold. When the filter cap 800 is rotated to be disengaged from the manifold, the end 836 of the lever 816 presses against one portion of the manifold, while the lever 816 pivots about the fulcrum 820. As the lever 816 pivots, the end with the angled edge 828 protrudes above the top surface 832 of the raised portion 804 (see FIG. 8B) and contacts a surface of the manifold. The interaction between the lever 816 and the manifold can help push the filter cap 800 from the manifold.

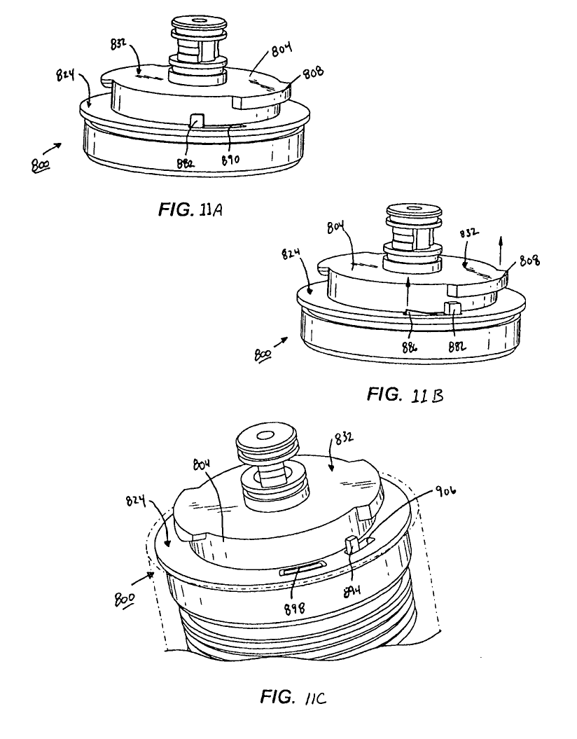

FIGS. 9A-9B illustrate another embodiment of the filter cap 800 having a release assembly 840. The release assembly 840 is coupled to the side of the raised portion 804 and generally includes a horizontally oriented pin 844 and a vertically oriented pin 848. The release assembly 840 can help disengage the filter cap 800 from the manifold of the refrigerator by pushing the vertically oriented pin 848 to contact the manifold. For example, in some embodiments, rotating the filter cap 800 causes a portion of the manifold to contact the horizontally oriented pin 844. As the filter cap 800 continues to be rotated, the horizontally oriented pin 844 contacts the vertically oriented pin 848, thereby forcing the vertically oriented pin 848 upward and against another portion of the manifold (see FIG. 9B). The top surface 832 of the raised portion 804 is therefore forced away from the manifold by the vertically oriented pin 848.

FIGS. 10A-10B illustrate another embodiment of the filter cap 800 having a dual-pronged release assembly 860 that is integrated into the top surface 824 of the filter cap 800. The dual-pronged release assembly 860 generally includes a first prong 864 that is positioned 90 degrees from a second prong 868 (FIG. 10B). Additionally, in some embodiments, the first prong 864 is relatively longer than the second prong 868. The dual-pronged release assembly 860 can be used to aid in the disengagement of the filter cap 800 from a manifold 872. For example, as the filter cap 800 is rotated, a lead portion 876 of the manifold 872 contacts the first prong 864 of the dual-pronged release assembly 860. As the filter cap 800 continues to rotate, the dual-pronged release assembly 860 pivots such that the second prong 868 of the dual-pronged release assembly 860 contacts the manifold 872. As a result, the second prong 868 forces the top surface 824 of the filter cap 800 away from the manifold (as shown in FIG. 10B).

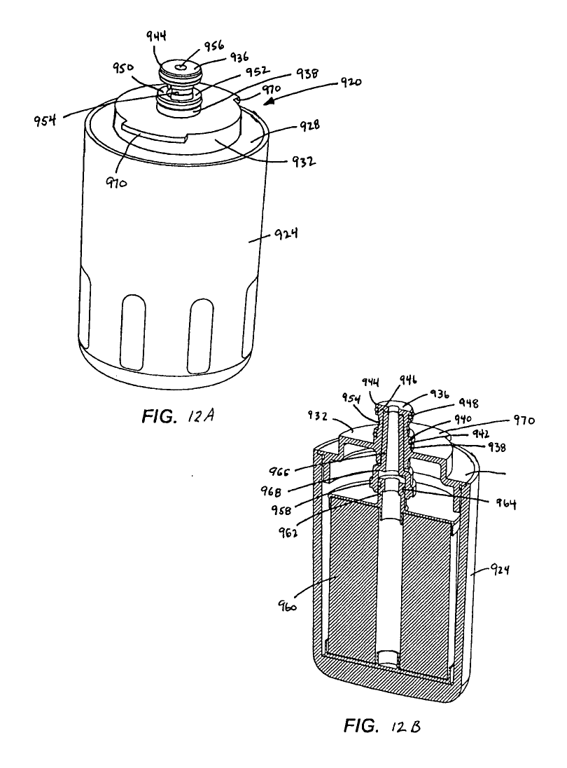

FIGS. 11A-11B illustrate another embodiment of the filter cap 800 having a release assembly that includes an actuator 882 and a release lever 886 (see FIG. 11B). In some embodiments, the actuator 882 and the release lever 886 are combined into a single, integral component. In other embodiments, the actuator 882 and the release lever 886 can be separate components (as described with respect to FIG. 11C). The actuator 882 is positioned generally perpendicular to the upper surface 824 of the filter cap 800, and protrudes above the upper surface 824 of the filter cap 800. When the actuator 882 is contacted by the manifold, the release lever 886 extends through a release lever slot 890 in the top surface 824 of the filter cap 800. Filter cap 800 rotation causes a portion of the manifold to contact the actuator 882. As the manifold contacts actuator 882, the actuator 882 is moved from a first position at one end of the slot release lever slot (see FIG. 11A) to a second position at another end of the release lever slot (see FIG. 11B). Concurrently, the release lever 886 extends through the release lever slot 890, eventually protruding above the upper surface 824 of the filter cap (see FIG. 11B). In some embodiments, the amount of the release lever 886 that is exposed and protruding above the upper surface 824 of the filter cap 800 is directly related to the distance that the actuator 882 travels along the release lever slot 890. When in the raised position (see FIG. 11B), the release lever 886 forces the filter cap 800 away from the manifold. Alternatively, the actuator 882 can be pivotally mounted on the filter cap 800. When the actuator 882 is contacted by the manifold, the release lever 886 extends through a release lever slot 890 in the top surface 824 of the filter cap 800, as previously described.

FIGS. 11C-11D illustrates another embodiment of the filter cap 800 with an actuator 894 and the release lever 898. In the embodiment illustrated in FIGS. 11C-11D, the actuator 894 and the release lever 898 are separate components. Similar to the embodiment shown in FIGS. 11A-11B, the actuator 894 is contacted by the manifold, causing the release lever 898 to move within a separate actuator slot 906. As the filter cap 800 is rotated for disengagement, the manifold contacts the actuator 894 causing the actuator 894 to move from a first position in the actuator slot 906 (see FIG. 11C) to a second position at the opposite end of the actuator slot 906. Additionally, a portion of the actuator 894 below the surface of the filter cap 800 (see FIG. 11D) that latches the release lever 898 in its lowered position releases release lever 898, allowing the spring-biased release lever 898 to travel from a lowered position to a raised position. In the raised position, the release lever 898 protrudes above the upper surface 824 of the filter cap 800, and contacts the manifold such that the filter cap 800 is forced away from the manifold. In some embodiments, the actuator 894 and/or the release lever 898 are spring loaded such that the actuator 894 is biased toward the first position (see FIG. 11C).

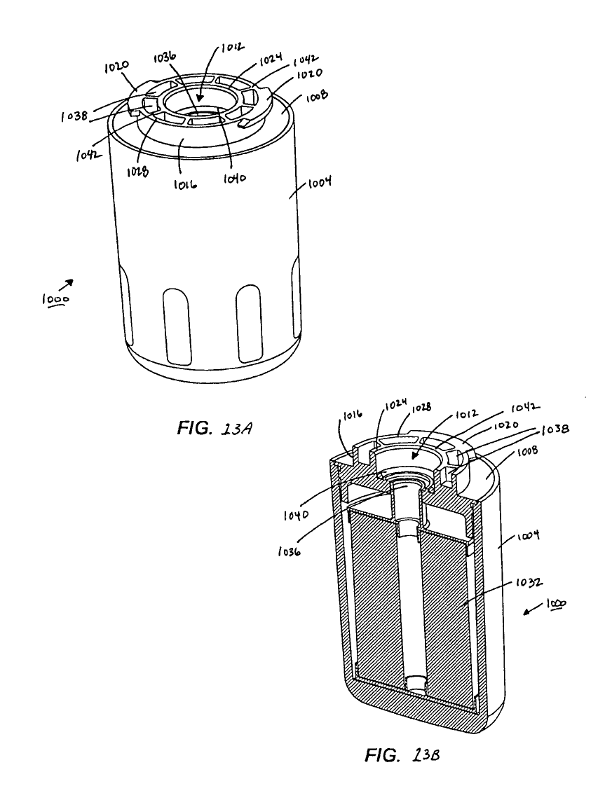

FIGS. 12A-12B illustrate a filter cartridge 920 having a filter body 924 and a filter cap 928. In some embodiments, the filter cap 928 includes a raised portion 932 and a neck 936. The neck 936 can include a non-uniform thickness along its length. For example, the neck 936 can include one or more steps, annular walls, and/or annular recesses. As shown in the cross-section view of FIG. 12B, the neck 936 can include a first annular wall 938, which can include an annular recess 940 that can receive an 0-ring 942. Similarly, the neck 936 can include a second annular wall 944, which can include an annular recess 946 that can receive an 0-ring 948. Between the first annular wall 938 and the second annular wall 944, the neck 936 can include one or more steps, such as a first stepped portion 950 and a second stepped portion 952, as shown in FIG. 12A. Within the steps, the neck 936 can include one or more inlet openings (not shown), which can allow water to enter the filter cartridge 920 from the manifold. The steps can include additional recessed walls 954 in order to create more space between the neck 936 and the manifold, in addition to the space created by the steps themselves. The walls 954 can be substantially flat or can be curved. An outlet opening 956 can be positioned on the second annular wall 944 in order to deliver filtered water back to the manifold.

Within the interior of the filter cartridge 920, a tube 958 can be coupled between the neck 936 and filter media 960. The filter media 960 can include a secondary neck 962 with an 0-ring 964, which can create a seal between the secondary neck 962 and the tube 958. The tube 958 can include a top portion 966 having a smaller diameter than a bottom portion 968. The outer surface of the tube 958 can include one or more longitudinal recesses (not shown) that provide a space for water to enter the filter cartridge 920 through the inlet openings. As shown in FIGS. 12A and 12B, the filter cartridge 920 can also include one or more tabs 970 (e.g., rectangular tabs). The tabs 970 can engage the manifold to retain the filter cartridge 920 within the manifold upon appropriate rotation.

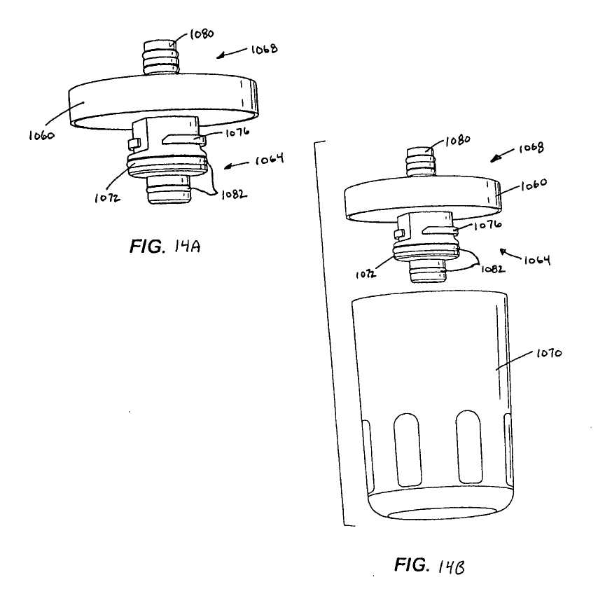

FIGS. 13A-13B illustrate a filter 1000 having a filter body 1004 and a filter cap 1008. Unlike the filters shown in FIGS. 1A-12B, the filter cap 1004 does not include a neck portion. Rather, the filter cap 1004 includes a recess 1012 that is surrounded by a raised portion 1016 having tabs 1020. In some embodiments, the raised portion 1016 also includes a first annular wall 1024 and a second annular wall 1028. In some embodiments, several recesses 1038 spaced apart by several radial walls 1042 can be positioned between the first annular wall 1042 and the second annular wall 1028.

The filter cap 1004 can be coupled to the manifold of a refrigerator by interfacing the raised portion 1016 of the filter cap 1004 with the manifold and rotating the filter 1000 until the tabs 1020 of the filter cap 1004 are secured by the manifold. After the filter cap 1004 is coupled to the manifold, the first annular wall 1024 and the second annular wall 1028 interface with the manifold. When the filter cap 1004 is coupled to the manifold, liquid can flow from the manifold into the recess 1012 through at least one inlet orifice (not shown) and into filter media 1032 (see FIG. 13B). After circulating through the filter media 1032, the liquid can be returned to the manifold through an outlet orifice 1036 in the center of the filter media 1032 and the recess 1012. In some embodiments, the at least one inlet orifice can include a first inlet orifice and a second inlet orifice positioned on opposing sides of a perimeter of the outlet orifice 1036. The first inlet orifice and the second inlet orifice can have a semi-circular shape, in one embodiment.

In some embodiments, the filter cap 1004 also includes one or more O-ring seals 1040 positioned around the orifice 1036. Compressing the O-ring seal 1040 between the manifold and the filter cap 1004 (when the filter cap 1004 is coupled to the manifold) can provide an additional leak reduction mechanism. For example, the O-ring seal 1040 can create a liquid tight seal with the manifold such that liquid is prevented from escaping in the area proximate to the orifice 1036. Additionally, the O-ring seal 1040 can be comprised of an elastomeric material (e.g., rubber) such that the O-ring seal 1040 provides a biasing force away from the manifold when the tabs 1020 are removed from the manifold. The combination of the walls 1024, 1028 (described above) and the O-ring seal 140 can create a relatively tight fit when the filter cap 1004 is coupled to the manifold. However, the relatively large amount of friction between the filter cap 1004 and the manifold can provide a relatively resilient liquid seal and can prevent unintended filter separation and/or filter loosening from the manifold.

FIGS. 14A-14B illustrate an adapter 1060 having filter end 1064 and a manifold end 1068. In some embodiments, the adapter 1060 can be coupled to a filter 1070 (see FIG. 14B) so that the filter 1070 can be used with a different style manifold. For example, in some embodiments, the filter end 1064 can be sized such that a filter neck 1072 of the adapter 1060 can be inserted into an orifice of the filter 1070. After inserting the filter neck 1072 into the filter, the adapter 1060 can be rotated such that tabs 1076 on the filter neck 1072 engage with the filter 1070. The combined filter 1070 and adapter 1060 can then be coupled to a manifold of a refrigerator by coupling a manifold neck 1080 of the adapter 1060 to a refrigerator manifold. The manifold neck 1080 can be similar to the neck 936 described with respect to FIGS. 12A and 12B. The filter neck 1072 can include one or more seals 1082. However, in some embodiments, the filter neck 1072 of the adapter 1060 can be free of seals, with seals only being positioned on one or more mating surfaces of the filter 1070.

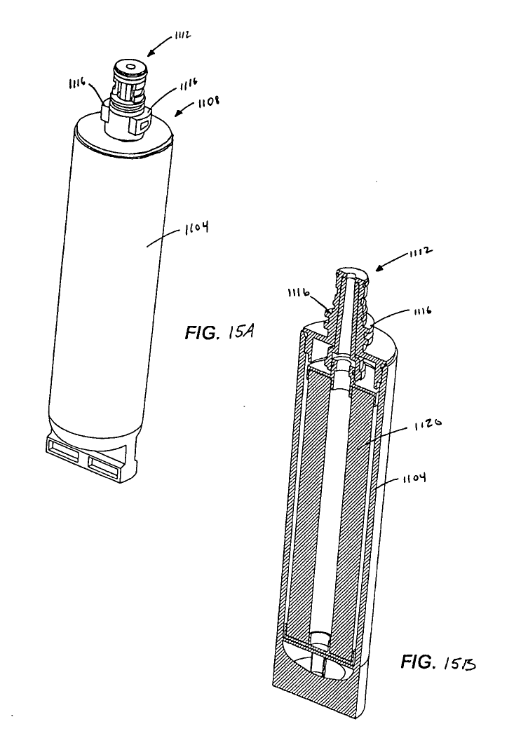

FIGS. 15A-15B illustrate a filter cartridge 1100 having a filter body 1104 and a filter cap 1108. In some embodiments, the filter cap 1108 includes a neck 1112 and a pair of tabs 1116. The tabs 1116 can be positioned on opposite sides of the neck 1112. The filter cartridge 1100 can include a neck 1112 similar to the neck 936 described with respect to FIGS. 12A and 12B.

During use, the filter cap 1108 can be coupled to a manifold of a refrigerator to provide a source of purified liquid. For example, in one embodiment, the neck 1112 of the filter cap 1108 is inserted into the manifold until the tabs 1116 interface with a portion of the manifold. The filter cap 1108 can be secured to the manifold by rotating the filter body 1104 one-half revolution in a conventional bayonet-mount configuration. In other embodiments, the filter body 1104 can be rotated more or less to secure the filter cap 1108 to the manifold. After the filter cap 1108 is secured to the manifold, liquid from the manifold can pass through the neck 1112 and into the filter body 1104. Once the liquid enters the filter body 1104, the liquid circulates through filter media 1120. Finally, the filtered liquid (i.e., the liquid that has passed through the filter media 1120) passes back through a center portion of the neck 1112, and is returned to the manifold. In other embodiments, the filter cartridge 1100 can be configured differently, having alternative components and paths for the liquid.

FIGS. 16A-16C illustrate a filter cartridge 1200 having a filter body 1204 and a filter cap 1208. In some embodiments, the filter cartridge 1200 is configured similar to the filter cartridge 1100. Also, the filter cartridge 1200 can include a neck similar to the neck 936 described with respect to FIGS. 12A-12B. However, the filter body 1204 and the filter cap 1208 shown in FIGS. 16A-16C can have an additional extendible portion. The filter body 1204 and the filter cap 1208 are conventionally sealed to one another in the retracted position shown in FIG. 16A. For example, in one embodiment, the filter cap 1208 includes an L-shaped slot 1212 that accommodates a protrusion 1216. The protrusion 1216 can be integrated into the side of the filter body 1204. Before decoupling the filter cartridge 1200 from the manifold, a user can rotate and pull on the filter body 1204 such that the protrusion 1216 is moved from a first position at an end of the short portion of the L-shaped slot 1212 (see FIG. 16A) to a second position at an end of the long portion the L-shaped slot 1212 (see FIG. 16B). As a result, a generally greater portion of the filter body 1204 is exposed. Exposing more of the filter body 1204 can allow a user to more easily grasp the filter body 1204, which can, in some embodiments, allow the filter cartridge 1200 to be removed from the manifold more easily. In other embodiments, filter body 1204 and the filer cap 1208 can be configured differently, having alternative guides and knobs.

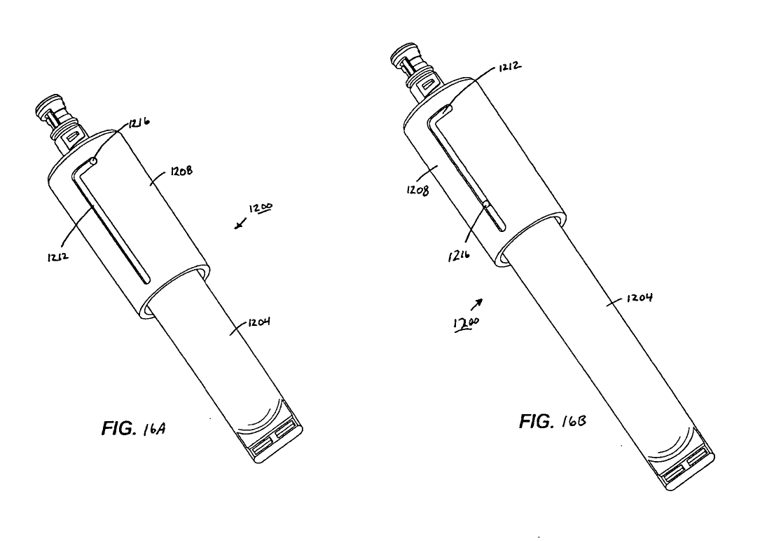

FIG. 17 illustrates an embodiment of a filter cartridge 1250 having a filter body 1254 and a filter cap 1258. In some embodiments, the filter cartridge 1250 is configured similar to the filter cartridges described with respect to FIGS. 15A-16C. Also, the filter cartridge 1250 can include a neck similar to the neck 936 described with respect to FIGS. 12A-12B. However, the filter cartridge 1250 can also include a filter handle 1262. The filter handle 1262 can be coupled to the bottom of the filter body 1254 (i.e., the end of the filter cartridge 1250 opposite the filter cap 1258). In one embodiment, the filter handle 1262 can be translated to slide along the length of the filter body 1254, which can provide a relatively large area for a user to grasp when removing the filter cap 1258 from the manifold. A protrusion 1266 of the filter body 1254 can be aligned with a guide slot 1270 in the filter handle 1262, allowing a user to pull the filter handle 1262 from a non-extended position to an extended position. The protrusion 1266 in the filter body 1254 can guide the filter handle 1262 from the retracted position to the extended position by following the slot 1270 in the filter handle 1262.

FIGS. 18A-18B illustrate a filter cartridge 1300 having a filter body 1304 and a filter cap 1308 that are configured similar to those described above. Also, the filter cartridge 1300 can include a neck similar to the neck 936 described with respect to FIGS. 12A-12B. However, the filter cartridge 1300 shown in FIGS. 18A-18B also includes a T-bar handle assembly 1330. The T-bar handle assembly 1330 can include a T-bar handle 1334 having a stem 1336 and an end portion 1338, and a stem receiver 1340. The stem 1336 of the T-bar handle assembly 1330 can be slidable within the stem receiver 1340 such that the T-bar handle 1334 can be transitioned from one position to another. For example, in an embodiment, the T-bar handle 1334 can be transitioned from a retracted position (see FIG. 18A), with the end portion 1338 proximate to the stem receiver 1340, to an extended position (see FIG. 18B), with the end portion 1338 positioned away from the stem receiver 1340. Accordingly, the T-bar handle 1334 can be extended to allow the user to grasp the T-bar handle 1334 and readily remove the filter cartridge 1300 from the manifold of the refrigerator.

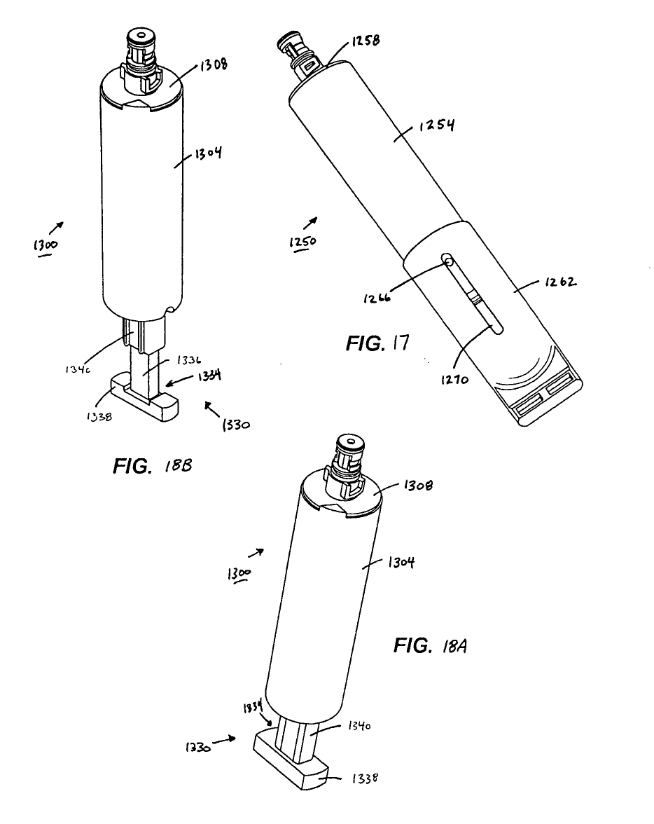

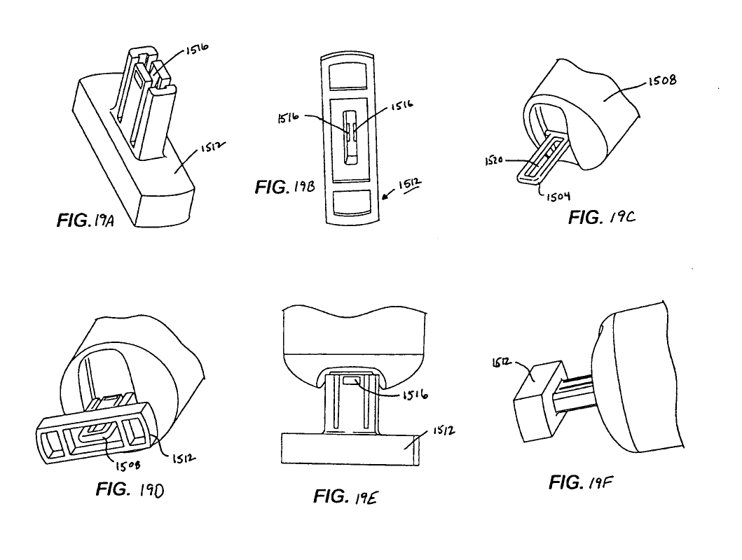

FIGS. 19A-19F illustrate multiple components a filter handle assembly 1500. In some embodiments, the filer handle assembly 1500 can include a support loop 1508 and a handle 1512, and can be adapted to an end of a filter body (such as the filter body 1304). For example, as shown in FIG. 19C, the support loop 1504 can be coupled to the end of a filter body 1508. Additionally, the handle 1512 can be coupled to the support loop 1504 by a pair of hooked elements 1516 (see FIGS. 19A-19B). In some embodiments the handle 1512 can be movable on the support loop 1504 such that the hooked elements 1516 can slide within an interior opening 1520 of the support loop 1504. As a result, the handle 1512 can move (or slide) from a first collapsed position (see FIGS. 19D-19F) with the pair of hooked elements located at the top of the support loop 1504, to a second extended position with the pair of hooked elements at the bottom of the support loop 1504.

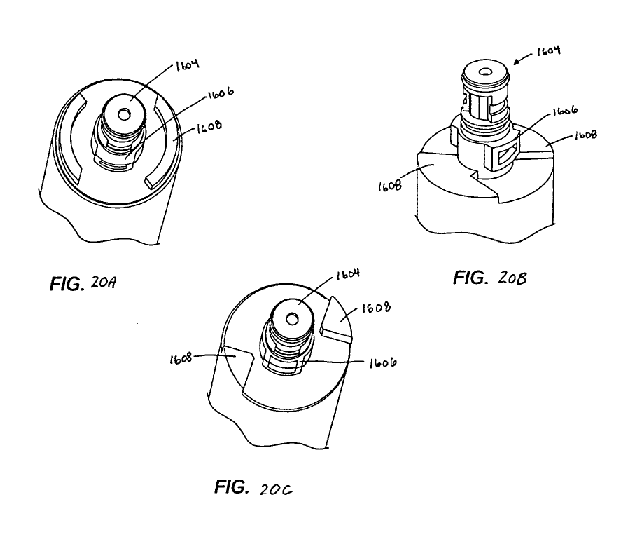

FIGS. 20A-20C illustrate an embodiment of a filter cap 1600. In some embodiments, the filter cap 1600 can be coupled to a filter body 1604 that is similar to the filter body 1300 (see FIGS. 18A-18E). The filter cap 1600 generally includes a neck 1604 having coupling tabs 1606 and a pair of end stops 1608. As previously described, the filter cap 1600 can be coupled to a manifold of a refrigerator by inserting the neck 1604 into the manifold and rotating the filter cap 1600 one half revolution until the coupling tabs 1606 are secured within the manifold. Likewise, the filter cap 1600 can be removed (or decoupled) from the manifold by rotating the filter cap 1600 in the direction opposite the coupling direction until the coupling tabs 1606 are freed from the manifold. Several embodiments described herein can include one or more cams that aid in the removal of a filter cap from the manifold. However, the filter cap 1600 includes no such cams. The end stops 1608 of the filter cap 1600 provide structures which stop the filter cap 1600 when the filter cap 1600 is fully rotated in the decoupling direction (e.g., rotated a full one-half revolution in the decoupling direction). Accordingly, the end stops 1608 can indicate to a user that the coupling tabs 1606 are clear of the manifold, and the neck 1604 can be pulled out of the manifold. In some embodiments, the end stops 1608 are included on filter cartridges that have handles, for example, the filter cartridges shown in FIGS. 18A-18E. In such embodiments, the end stops 1608 can provide an indication that the filer cartridge is in the proper removal position, while the handles can provide a mechanism to aid in the removal of the filter cartridge from the manifold.

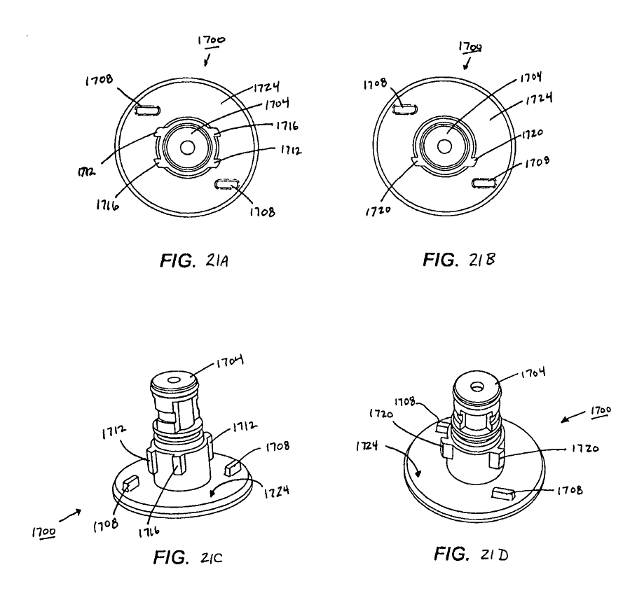

FIGS. 21A-21D illustrate an embodiment of a filter cap 1700 that includes a neck 1704 and a pair of end stops 1708. Additionally, in the embodiment shown in FIGS. 21A and 21C, the neck 1704 includes a first pair of ribs 1712 and a second pair of ribs 1716, while the neck 1704 in the embodiment shown in FIGS. 21B and 21D includes only a single pair of ribs 1720. In some embodiments, the first pair of ribs 1712 are shaped and sized differently than the second pair of ribs 1716. For example, in an embodiment, the first pair of ribs 1712 are relatively longer than the second pair of ribs 1716 (see FIG. 21C). Additionally, in some embodiments, the first and second pair of ribs 1712 and 1716 are positioned staggered around the radius of the neck 1704, such that each of the ribs of the first pair 1712 are positioned opposite each other on the neck 1704 and each of the ribs of the second pair 1716 are positioned opposite each other on the neck 1704 (see FIG. 21A).

The filter cap 1700 can be coupled a manifold of a refrigerator in a manner similar to that described with respect to FIGS. 15A-15B. However, rather than securing the filter cap 1700 to the manifold using coupling tabs (as used in the embodiments shown in FIGS. 15A-15B), the ribs 1712-1720 can be used to secure the filter cap 1700 to the manifold. For example, the neck 1704 of the filter cap 1700 can be inserted into the manifold until an upper surface 1724 of the filter cap 1700 interfaces with a corresponding surface of the manifold. The filter cap 1700 can then be rotated (e.g., rotated one-half revolution) until the ribs 1712-1720 are secured by the manifold. To release the filter cap 1700 from the manifold, the filter cap 1700 can be rotated in the opposite direction (e.g., the direction opposite the coupling direction) until the end stops 1708 contact the manifold and stop the rotation of the filter cap 1700, indicating that the protrusions 1712-1720 of the filter cap 1700 are free of the manifold. The filter cap 1700 can then be removed from the manifold. In some embodiments, the end stops 1708 can be shaped as relatively small knobs that protrude from the upper surface 1724 of the filer cap 1700. In other embodiments, the end stops 1708 may be shaped differently (e.g., having greater or smaller widths, heights, lengths, etc.) and can be used as camming elements to help disengage the filter cap 1700 from the manifold.

Various embodiments of the invention are set forth in the following claims.

1. A filter cartridge for use with a manifold of an appliance, the filter cartridge comprising:
a base portion having a top and a bottom;
a handle coupled to the bottom of the base portion, the handle adapted to be grasped in order to remove the filter cartridge from the manifold.

2. The filter cartridge of claim 1 wherein the bottom of the base portion includes a recessed annular wall, and wherein the handle includes at least one strap element received within the recessed annular wall.

3. The filter cartridge of claim 2 wherein the at least one strap element rotates between a first position received within the recessed annular wall and a second position rotated a distance from the bottom of the base portion.

4. The filter cartridge of claim 1 wherein the handle includes T-shaped bar with a center piece coupled to the bottom of the base portion.

5. The filter cartridge of claim 1 wherein the handle includes a block handle coupled to the bottom of the base portion along at least one of substantially an entire length of the block handle and substantially an entire width of the base portion.

6. The filter cartridge of claim 1 wherein the handle includes a block handle coupled to the bottom of the base portion, the block handle having at least one tapered portion.

7. The filter cartridge of claim 1 wherein the handle includes a squared handle with an opening.

8. A filter cartridge for use with a manifold of an appliance, the filter cartridge comprising:
a filter body having a top; and
a filter cap coupled to the top of the filter body, the filter cap having a first top surface, a raised portion coupled to the first top surface, the raised portion having a second top surface, and a neck coupled to the second top surface of the raised portion;
the raised portion having a cam element, the cam element including a first cam portion, a middle cam portion, and an end cam portion;
the middle cam portion positioned substantially parallel to the raised portion;
the first cam portion extending at a first angle between the middle cam portion and at least toward the second top surface; and
the end cam portion extending at a second angle between the middle cam portion and at least toward the first top surface.

9. The filter cartridge of claim 8 wherein the end cam portion extends to reach the first top surface.

10. The filter cartridge of claim 8 wherein the first cam portion engages the manifold to draw the filter cartridge toward the manifold upon rotation of the filter body in a first direction.

11. The filter cartridge of claim 8 wherein the end cam portion engages the manifold to withdraw the filter cartridge from the manifold upon rotation of the filter body in a second direction.

12. The filter cartridge of claim 8 wherein the neck includes at least one seal.

13. The filter cartridge of claim 8 wherein the neck has a non-uniform diameter.

14. The filter cartridge of claim 8 and further comprising a second cam element.

15. A filter cartridge for use with a manifold of an appliance, the filter cartridge comprising:
a filter body having a top; and
a filter cap coupled to the top of the filter body, the filter cap having a first top surface, a raised portion coupled to the first top surface, the raised portion having a second top surface, and a neck coupled to the second top surface of the raised portion, the raised portion having a rectangular tab, the rectangular tab positioned substantially parallel to the second top surface.

16. The filter cartridge of claim 15 wherein the rectangular tab engages the manifold upon rotation of the filter body in a first direction.

17. The filter cartridge of claim 15 wherein the neck includes at least one seal.

18. The filter cartridge of claim 15 wherein the neck has a non-uniform diameter.

19. The filter cartridge of claim 15 and further comprising a second rectangular tab.

20. A filter cartridge for use with a manifold of an appliance, the filter cartridge comprising:
a filter body having a top;
a nut positioned around a perimeter of the top of the filter body, the nut being rotatable with respect to the filter body in order to selectively engage the manifold; and
a filter cap coupled to the top of the filter body, the filter cap having a first top surface, a raised portion coupled to the first top surface, the raised portion having a second top surface, and a neck coupled to the second top surface of the raised portion, the raised portion having a tab, the tab positioned substantially parallel to the second top surface.

21. The filter cartridge of claim 20 wherein the filter body includes a pin and the nut includes a slot that receives the pin, the slot being angled with respect to the first top surface.

22. The filter cartridge of claim 20 wherein the tab includes a square end and an angled end, the angled end engaging the manifold to draw the filter cartridge toward the manifold upon rotation of the filter body.

23. The filter cartridge of claim 20 wherein the nut is rotated upward toward the neck to engage the manifold in order to withdraw the filter cartridge from the manifold.

24. The filter cartridge of claim 20 wherein the neck includes at least one seal.

25. The filter cartridge of claim 20 wherein the neck has a non-uniform diameter.

26. The filter cartridge of claim 20 and further comprising a second tab.

27. The filter cartridge of claim 20 wherein the filter body is rotated in a first direction to disengage the filter cartridge from the manifold and the nut is rotated in a second direction to further disengage the filter cartridge from the manifold, the first direction being different from the second direction.

28. The filter cartridge of claim 27 wherein the first direction is counterclockwise and the second direction is clockwise.

29. The filter cartridge of claim 20 wherein the nut is threaded onto the top of the filter body.

30. A filter cartridge for use with a manifold of an appliance, the filter cartridge comprising:
a filter body having a top; and
a filter cap coupled to the top of the filter body, the filter cap having a first top surface, a raised portion coupled to the first top surface, the raised portion having a second top surface, and a neck coupled to the second top surface of the raised portion;
a tab coupled to the raised portion, the tab positioned substantially parallel to the second top surface;
a fulcrum coupled to the first top surface, the fulcrum having a pivot point;
a lever coupled to the fulcrum at the pivot point, the lever pivoting between a first position not engaging the manifold and a second position engaging the manifold.

31. The filter cartridge of claim 30 wherein the tab includes a square end and an angled end, the angled end engaging the manifold to draw the filter cartridge toward the manifold upon rotation of the filter body.

32. The filter cartridge of claim 30 wherein the neck includes at least one seal.

33. The filter cartridge of claim 30 wherein the neck has a non-uniform diameter.

34. The filter cartridge of claim 30 and further comprising a second tab, a second fulcrum, and a second lever.

35. The filter cartridge of claim 30 wherein the lever is biased toward the second position to engage the manifold.

36. The filter cartridge of claim 30 wherein the lever includes a first arm coupled to a second arm at an angle.

37. A filter cartridge for use with a manifold of an appliance, the filter cartridge comprising:
a filter body having a top;
a filter cap coupled to the top of the filter body, the filter cap having a top surface, a neck coupled to the top surface; and
at least one spring coupled to at least one of the filter body and the filter cap to bias the filter cartridge away from the manifold.

38. The filter cartridge of claim 37 wherein the filter cap includes at least one disengagement block coupled to the at least one spring.

39. The filter cartridge of claim 38 wherein the at least one spring is at least one coil spring positioned between the at least one disengagement block and the filter body.

40. The filter cartridge of claim 37 wherein the neck is biased by the at least one spring.

41. The filter cartridge of claim 40 wherein the at least one spring is at least one coil spring positioned between the neck and the filter body.

42. The filter cartridge of claim 37 wherein the filter cap includes a raised portion, the raised portion includes a tab, and the at least one spring is at least one straight leaf spring coupled to the tab at an angle with respect to the top surface.

43. The filter cartridge of claim 37 wherein the at least one spring is at least one curved leaf spring, a first end and a second end of each one of the at least one curved spring coupled to the top surface.

44. The filter cartridge of claim 37 wherein at least one spring includes at least one spring-biased button coupled to the filter cap.

45. The filter cartridge of claim 37 wherein the at least one spring includes at least one straight leaf spring extending from the top surface at an angle with respect to the top surface.

46. The filter cartridge of claim 45 wherein the at least one leaf spring is curved with respect to an axis parallel to the neck.

47. The filter cartridge of claim 37 wherein the at least one spring includes at least one S-shaped spring.

48. The filter cartridge of claim 37 wherein the neck includes at least one seal.

49. The filter cartridge of claim 37 wherein the neck has a non-uniform diameter.

50. A filter cartridge for use with a manifold of an appliance, the filter cartridge comprising:
a filter body having a top;
a filter cap coupled to the top of the filter body, the filter cap having a first top surface, a raised portion coupled to the first top surface, the raised portion having a second top surface, and a neck coupled to the second top surface of the raised portion; and
a release assembly coupled to one of the first top surface and the second top surface, the release assembly including a horizontal pin and a vertical pin, the horizontal pin being engaged by the manifold upon rotation of the filter body, the vertical pin being engaged by the horizontal pin, the vertical pin moving upward to engage the manifold.

51. The filter cartridge of claim 50 and further comprising a tab coupled to the raised portion, the tab positioned substantially parallel to the second top surface.

52. The filter cartridge of claim 51 wherein the tab includes a square end and an angled end, the angled end engaging the manifold to draw the filter cartridge toward the manifold upon rotation of the filter body.

53. The filter cartridge of claim 50 wherein the neck includes at least one seal.

54. The filter cartridge of claim 50 wherein the neck has a non-uniform diameter.

55. A filter cartridge for use with a manifold of an appliance, the filter cartridge comprising:
a filter body having a top;
a filter cap coupled to the top of the filter body, the filter cap having a first top surface, a raised portion coupled to the first top surface, the raised portion having a second top surface, and a neck coupled to the second top surface of the raised portion, the first top surface including at least one slot; and
a release assembly coupled to the first top surface, the release assembly including an actuator and a release lever, the actuator protruding from the at least one slot, the actuator being engaged by the manifold to move from a first position to a second position upon rotation of the filter body, the actuator in the second position causing the release lever to move through the at least one slot to engage the manifold.

56. The filter cartridge of claim 55 and further comprising a tab coupled to the raised portion, the tab positioned substantially parallel to the second top surface.

57. The filter cartridge of claim 56 wherein the tab includes a square end and an angled end, the angled end engaging the manifold to draw the filter cartridge toward the manifold upon rotation of the filter body.

58. The filter cartridge of claim 55 wherein the actuator is integral with the release lever, and the release lever pivots to engage the manifold.

59. The filter cartridge of claim 55 wherein the actuator disengages from the release lever causing the release lever to translate upward to engage the manifold.

60. The filter cartridge of claim 55 wherein the actuator is biased toward the first position.

61. The filter cartridge of claim 55 wherein the release lever is biased toward the manifold.

62. The filter cartridge of claim 55 wherein the neck includes at least one seal.

63. The filter cartridge of claim 55 wherein the neck has a non-uniform diameter.

64. A filter cartridge for use with a manifold of an appliance, the filter cartridge comprising:
a filter body having a top;
a filter cap coupled to the top of the filter body, the filter cap including a neck, the neck having at least one annular wall and at least one stepped portion for a non-uniform diameter along a longitudinal length.

65. The filter cartridge of claim 64 wherein the filter cap includes a first top surface, and further comprising a raised portion coupled to the first top surface, the raised portion having a second top surface, a tab coupled to the raised portion, the tab positioned substantially parallel to the second top surface.

66. The filter cartridge of claim 65 wherein the tab includes a square end and an angled end, the angled end engaging the manifold to draw the filter cartridge toward the manifold upon rotation of the filter body.

67. The filter cartridge of claim 65 wherein the tab is a rectangular tab, and further comprising at least one ramp coupled to the second top surface.

68. The filter cartridge of claim 64 wherein the neck includes at least one seal positioned within at least one annular recess within the at least one annular wall.

69. The filter cartridge of claim 64 and further comprising a tube coupled within the neck between the neck and filter media.

70. The filter cartridge of claim 69 wherein the tube includes at least one longitudinal recess to receive water from the manifold through an inlet opening in the filter cartridge.

71. The filter cartridge of claim 64 wherein the filter cap includes at least one end stop.

72. The filter cartridge of claim 71 wherein the at least one end stop is coupled to one of the neck and a top surface of the filter cap.

73. The filter cartridge of claim 71 wherein the at least one end stop includes a substantially curved shape.

74. The filter cartridge of claim 71 wherein the at least one end stop includes a substantially triangular shape.

75. The filter cartridge of claim 71 wherein the at least one end stop includes a substantially straight shape.

76. The filter cartridge of claim 71 wherein the at least one end stop includes a rib coupled to the neck.

77. A filter cartridge for use with a manifold of an appliance, the filter cartridge comprising:
a filter body having a top; and
a filter cap coupled to the top of the filter body, the filter cap having a first top surface,
the filter cap having raised portion coupled to the first top surface;
the filter cap having a recess surrounded by the raised portion, the recess including at least one seal.

78. The filter cartridge of claim 77 and further comprising a tab coupled to the raised portion, the tab positioned substantially parallel to a second top surface of the raised portion.

79. The filter cartridge of claim 78 wherein the tab includes a square end and an angled end, the angled end engaging the manifold to draw the filter cartridge toward the manifold upon rotation of the filter body.

80. The filter cartridge of claim 77 wherein the recess includes at least one inlet orifice and at least one outlet orifice.

81. The filter cartridge of claim 77 wherein the raised portion includes a first annular wall and a second annular wall.

82. The filter cartridge of claim 81 wherein the raised portion includes a plurality of recesses and a plurality of radial walls between the first annular wall and the second annular wall.

83. A filter cartridge system for use with a manifold of an appliance, the filter cartridge system comprising:
a filter having at least one seal; and
an adapter removably coupled to the filter, the adapter including a filter end and a manifold end,
the filter end including a filter neck being free of seals, and
the manifold end having a manifold neck, the manifold neck having at least one annular wall and at least one stepped portion for a non-uniform diameter along a longitudinal length.

84. The filter cartridge system of claim 83 wherein the adapter does not include a check valve.

85. The filter cartridge system of claim 83 wherein the filter end includes a tab having at least one angled end.

86. The filter cartridge system of claim 83 wherein the manifold neck includes at least one seal positioned within at least one annular recess within the at least one annular wall.

87. A filter cartridge for use with a manifold of an appliance, the filter cartridge comprising:
a filter body having a top, the filter body including a protrusion; and
a filter cap coupled to the top of the filter body, the filter cap including an annular wall positioned around a perimeter of the filter body, the annular wall including a slot that receives the protrusion, the protrusion moving away from the top of the filter body to extend the filter body and increase a total length of the filter cartridge.

88. The filter cartridge of claim 87 wherein the filter cap includes a neck and at least one tab coupled to the neck.

89. The filter cartridge of claim 88 wherein the at least one tab includes a bottom surface that is angled with respect to a top surface of the filter body.

90. The filter cartridge of claim 88 wherein the neck includes at least one seal positioned within at least one annular recess within the at least one annular wall.

91. The filter cartridge of claim 87 wherein the slot is substantially L-shaped.

92. A filter cartridge for use with a manifold of an appliance, the filter cartridge comprising:
a filter body having a top and a bottom, the filter body including a protrusion;
a filter cap coupled to the top of the filter body; and
a handle coupled to the bottom of the filter body, the handle including an annular wall positioned around a perimeter of the filter body, the annular wall including a slot that receives the protrusion, the handle moving away from the top of the filter body to extend the filter body and increase a total length of the filter cartridge.

93. The filter cartridge of claim 92 wherein the filter cap includes a neck and at least one tab coupled to the neck.

94. The filter cartridge of claim 93 wherein the at least one tab includes a bottom surface that is angled with respect to a top surface of the filter body.

95. The filter cartridge of claim 93 wherein the neck includes at least one seal positioned within at least one annular recess within the at least one annular wall.

96. A filter cartridge for use with a manifold of an appliance, the filter cartridge comprising:
a filter body having a top and a bottom;
a filter cap coupled to the top of the filter body; and
a handle coupled to the bottom of the filter body, the handle including a T-bar handle assembly having a stem receiver, a stem, and an end portion, the stem and the end portion moving away from the top of the filter body to extend the filter body and increase a total length of the filter cartridge.

97. The filter cartridge of claim 96 wherein the filter cap includes a neck and at least one tab coupled to the neck.

98. The filter cartridge of claim 97 wherein the at least one tab includes a bottom surface that is angled with respect to a top surface of the filter body.

99. The filter cartridge of claim 97 wherein the neck includes at least one seal positioned within at least one annular recess within the at least one annular wall.
